(19) United States
(12) Patent Application Publication
(10) Pub. No.: US 2016/0274709 A1
(43) Pub. Date: Sep. 22, 2016

(54) PRESSURE SENSOR FOR TOUCH PANEL

(71) Applicant: NAOPLUS CO., LTD., Gyeonggi-do (KR)

(72) Inventors: Young-Bae YANG, Gyeonggi-do (KR); Dong-Gyu JUNG, Gyeonggi-do (KR)

(21) Appl. No.: 14/661,442

(22) Filed: Mar. 18, 2015

(51) Int. Cl. G06F 3/041; G06F 3/045

(52) U.S. Cl. CPC G06F 3/0414; G06F 3/045

(57) ABSTRACT

Provided is a pressure sensor for a touch panel, including a signal input member configured to have conductors patterned thereon in an interdigitated form on a substrate, a spacer disposed at a corner where the conductor patterns are not formed on the substrate of the signal input member, and a piezo film disposed over the spacer, spaced apart from the signal input member, and configured to have a resistance value varied depending on the amount of pressure applied to the piezo film, wherein an interval between the conductor patterns formed in the signal input member and disposed close to the spacer is smaller than an interval between the conductor patterns formed in the signal input member and disposed at the farthest place from the spacer.

### BACKGROUND

The present invention relates to a pressure sensor for a touch panel and, more particularly, to a pressure sensor for a touch panel, which is capable of effectively preventing an error of a touch input.

In general, in a device, such as a Personal Computer (PC) or a network terminal, a keyboard is widely used as means for an interface between the device and a user.

Most of keyboards have mechanical elements. Springs and switches are disposed under keys fabricated by injection molding. When a user strikes a key using specific strength, a corresponding switch is manipulated by overcoming its elastic force, thereby performing a key input.

In addition to the keyboard having such mechanical elements, a keyboard using a touch panel method has emerged. The keyboard using a touch panel method is equipped with technical means for detecting and recognizing whether contact with the human body (e.g., a finger) or a pen has been made or not based on the detection of current of the human body or a change in pressure or temperature according to the touch. In particular, a touch panel using a method of detecting whether contact with the human body or a pen has been made or not using a change in pressure has been in the spotlight.

In such a touch panel using a pressure sensor, a piezo film is disposed on top of a spacer, but there is a problem in that an error of a touch input is generated at a place close to the spacer.

The background of the present invention is disclosed in Korean Patent No. 10-1094165 (Dec. 8, 2011).

### SUMMARY OF THE INVENTION

Accordingly, the present invention has been made keeping in mind the above problems occurring in the prior art, and an object of the present invention is to provide a pressure sensor for a touch panel, which is capable of effectively preventing an error of a touch input by more densely arranging conductor patterns, formed in a signal input member and disposed close to a spacer, than conductor patterns disposed at the farthest place from the spacer.

A pressure sensor for a touch panel in accordance with an embodiment of the present invention includes a signal input member configured to have conductors patterned thereon in an interdigitated form on a substrate, a spacer disposed at a corner where the conductor patterns are not formed on the substrate of the signal input member, and a piezo film disposed over the spacer, spaced apart from the signal input member, and configured to have a resistance value varied depending on the amount of pressure applied to the piezo film, wherein an interval D1 between the conductor patterns formed in the signal input member and disposed close to the spacer is smaller than an interval D2 between the conductor patterns formed in the signal input member and disposed at the farthest place from the spacer.

In the pressure sensor for a touch panel in accordance with an embodiment of the present invention, the interval D1 between the conductor patterns formed in the signal input member and disposed close to the spacer may be 0.2˜0.6 times the interval D2 between the conductor patterns formed in the signal input member and disposed at a farthest place from the spacer.

In the pressure sensor for a touch panel in accordance with an embodiment of the present invention, the spacer may have a height of 0.08˜0.15 mm.

### BRIEF DESCRIPTION OF THE DRAWINGS

FIG. 1 is a perspective view of a pressure sensor for a touch panel in accordance with an embodiment of the present invention; and

FIG. 2 is a cross-sectional view of the pressure sensor for a touch panel in accordance with an embodiment of the present invention.

### DETAILED DESCRIPTION OF THE INVENTION

The details of other embodiments are included in the detailed description and the drawings.

The merits and characteristics of the present invention and a method for achieving the merits and characteristics will become more apparent from embodiments described in detail later in conjunction with the accompanying drawings. However, the present invention is not limited to the disclosed embodiments, but may be implemented in various ways. The embodiments are provided to complete the disclosure of the present invention and to allow those skilled in the art to understand the scope of the present invention. The present invention is defined by the category of the claims. The same reference numbers will be used to refer to the same or similar parts throughout the drawings.

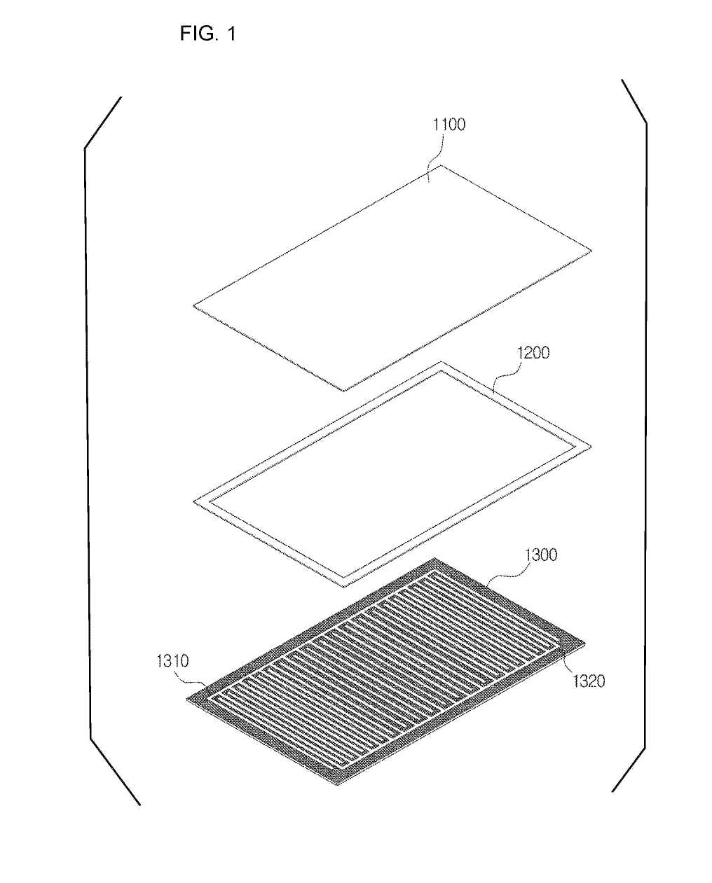

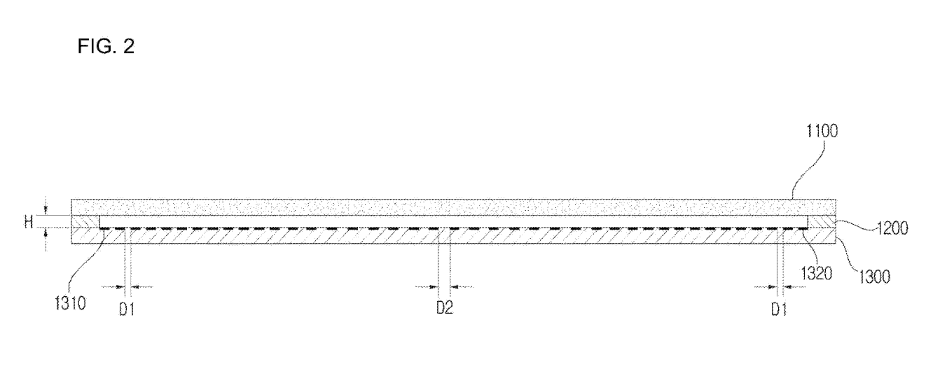

As shown in FIGS. 1 and 2, a pressure sensor for a touch panel in accordance with an embodiment of the present invention is configured to include a signal input member 1300, a spacer 1200, and a piezo film 1100.

As shown in FIG. 1, the signal input member 1300 is configured to have conductors patterned thereon in an interdigitated form on a substrate.

In this case, conductor patterns 1310 on one side are formed in parallel in a comb pattern and are connected on the lower part. Conductor patterns 1320 on the other side are formed in parallel in a comb pattern, are connected on the upper part, and are arranged as if they are interdigitated with the conductors 1310.

The spacer 1200 is disposed at the corner on the substrate of the signal input member 1300 in which the conductor patterns 1310 and 1320 are not formed.

The piezo film 1100 is disposed over the spacer 1200 and is spaced apart from the signal input member 1300. When the amount of pressure applied to the piezo film 1100 increases, the resistance value of the piezo film 1100 decreases. When the amount of pressure applied to the piezo film 1100 decreases, the resistance value of the piezo film 1100 increases.

When a touch is applied to the piezo film 1100, the resistance value of the piezo film 1100 is changed depending on the amount of touch pressure. As described above, when touch pressure is increased, the resistance value the piezo film 1100 is reduced. As a result, a key input can be detected because a power source voltage applied to the piezo film 1100 is reduced.

In the pressure sensor for a touch panel in accordance with an embodiment of the present invention, the interval D1 between the conductor patterns 1310 and 1320 that are formed in the signal input member 1300 and that are disposed close to the spacer 1200 is smaller than the interval D2 between the conductor patterns 1310 and 1320 that are formed in the signal input member 1300 and that are disposed at the farthest place from the spacer 1200.

More specifically, the interval D1 between the conductor patterns 1310 and 1320 that are formed in the signal input member 1300 and that are disposed close to the spacer 1200 is 0.2˜0.6 times the interval D2 between the conductor patterns 1310 and 1320 that are formed in the signal input member 1300 and that are disposed at the farthest place from the spacer 1200.

If the interval D1 between the conductor patterns 1310 and 1320 disposed close to the spacer 1200 is identical with the interval D2 between the conductor patterns 1310 and 1320 disposed at the farthest place from the spacer 1200, an error of a touch input may occur because touch pressure is not sufficiently transferred to the conductor patterns 1310 and 1320, disposed close to the spacer 1200, due to the spacer 1200.

In the pressure sensor for a touch panel in accordance with an embodiment of the present invention, however, the conductor patterns 1310 and 1320 formed in the signal input member 1300 and disposed close to the spacer 1200 are more densely arranged than the conductor patterns 1310 and 1320 formed in the signal input member 1300 and disposed at the farthest place from the spacer 1200 as described above. Accordingly, although low pressure is transferred to the conductor patterns 1310 and 1320 disposed close to the spacer 1200 due to the spacer 1200, an error of a touch input can be effectively suppressed.

In the pressure sensor for a touch panel in accordance with an embodiment of the present invention, the pressure of a touch input can be effectively transferred to the conductor patterns 1310 and 1320 and the pressure sensor can also be sufficiently thinly fabricated by controlling the height H of the spacer 1200 in thickness of about 0.08˜0.15 mm.

In the pressure sensor for a touch panel in accordance with an embodiment of the present invention, the conductor patterns formed in the signal input member and disposed close to the spacer are more densely arranged than the conductor patterns disposed at the farthest place from the spacer. Accordingly, an error of a touch input can be effectively prevented.

As described above, those skilled in the art to which the present invention pertains will appreciate that the present invention may be implemented in different detailed ways without departing from the technical spirit or essential characteristics of the present invention. Accordingly, the aforementioned embodiments should be construed as being only illustrative, but should not be constructed as being restrictive from all aspects. The scope of the present invention is defined by the following claims rather than the detailed description, and the meanings and scope of the claims and all changes or modified forms derived from their equivalents should be construed as falling within the scope of the present invention.

What is claimed is:

1. A pressure sensor for a touch panel, comprising:
a signal input member configured to have conductors patterned thereon in an interdigitated form on a substrate;
a spacer disposed at a corner where the conductor patterns are not formed on the substrate of the signal input member and; and
a piezo film disposed over the spacer, spaced apart from the signal input member, and configured to have a resistance value varied depending on an amount of pressure applied to the piezo film,
wherein an interval D1 between the conductor patterns formed in the signal input member and disposed close to the spacer is smaller than an interval D2 between the conductor patterns formed in the signal input member and disposed at a farthest place from the spacer.

2. The pressure sensor of claim 1, wherein the interval D1 between the conductor patterns formed in the signal input member and disposed close to the spacer is 0.2˜0.6 times the interval D2 between the conductor patterns formed in the signal input member and disposed at a farthest place from the spacer.

3. The pressure sensor of claim 1, wherein the spacer has a height of 0.08˜0.15 mm.
